(19) United States
(12) Patent Application Publication
(10) Pub. No.: US 2013/0285995 A1
(43) Pub. Date: Oct. 31, 2013

(54) CIRCUIT WITH POWER SAVING FUNCTION

(71) Applicants: JIE-SONG ZHOU, Shenzhen City (CN); XIAO-QING ZHANG, Shenzhen City (CN)

(72) Inventors: JIE-SONG ZHOU, Shenzhen City (CN); XIAO-QING ZHANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/517,609

(22) Filed: Jun. 14, 2012

(30) Foreign Application Priority Data
Apr. 25, 2012 (CN) 201210124275.7

(51) Int. Cl. G09G 5/00; G09G 3/36

(52) U.S. Cl. 345/211; 345/87

(57) ABSTRACT

A circuit with power saving function connected to a LCD includes a display signal output module, to output a display control signal; a boosting circuit; a Content Adaptive Backlight Control (CABC) control module, to output a CABC signal; and a combining circuit, connected between the display signal output module and the CABC control module, to combine the display control signal outputted by the display signal output module and the CABC signal outputted by the CABC control module, then output a combined signal to an input port of the boosting circuit. The boosting circuit is configured to boost the combined signal and output a boosted combined signal to the LCD, thereby changing the backlighting of the LCD to save energy.

### BACKGROUND

1. Technical Field

The present disclosure relates to circuits with power saving function, and more particularly to a circuit with power saving function applied in Liquid Crystal Display (LCD).

2. Description of Related Art

FIG. 1 shows a conventional circuit with power saving function 10 connected to an LCD 20 to control backlighting (color/level) of the LCD 20. The circuit 10 includes a display signal output module 100, a boosting circuit 200 and a Content

Adaptive Backlight Control (CABC) control module 300. The display signal output module 100 is connected to an input port EN of the boosting circuit 200, to output a display control signal to the boosting circuit 200. An output port VOUT of the boosting circuit 200 is connected to the LCD 20, to boost the display control signal and output a boosted display control signal to the LCD 20, thereby controlling the LCD 20 display.

The CABC control module 300 is connected to a feedback port FB of the boosting circuit 200, to output the CABC signal to the feedback port FB of the boosting circuit 200, thus changing the boosted display control signal to the LCD 20 and the backlighting of the LCD 20, to save energy. However, when the duty cycle of the CABC signal changes, the backlighting of the LCD cannot change proportionally with display information on the LCD corresponding to the display control signal.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments.

FIG. 1 is a schematic circuit diagram of a conventional circuit with power saving function.

FIG. 2 is a schematic circuit diagram of one embodiment of a circuit with power saving function in accordance with the present disclosure.

### DETAILED DESCRIPTION

Embodiments of the present disclosure will be described with reference to the accompanying drawings.

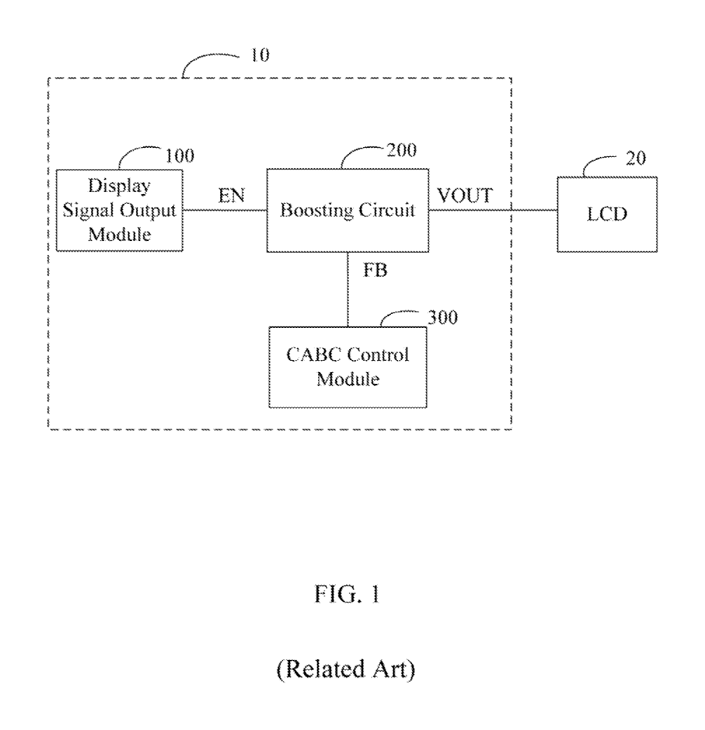

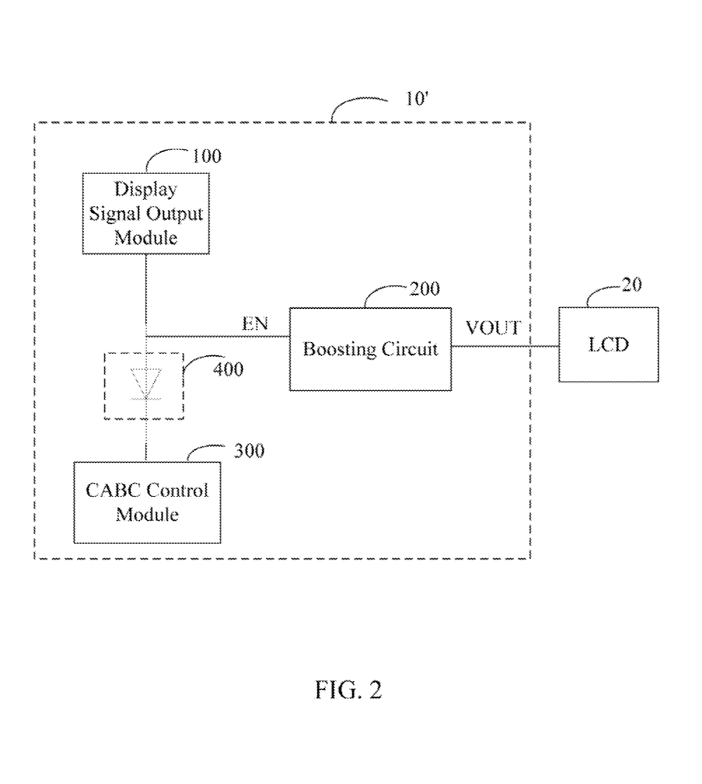

FIG. 2 is a schematic circuit diagram of one embodiment of a circuit with power saving function in accordance with the present disclosure. Compared with the circuit of FIG. 1, the circuit 10′ in FIG. 2 further includes a combining circuit 400 connected between the display signal output module 100 and the CABC control module 300, to combine the CABC signal output by the CABC control module 300 and the display control signal output by the display signal output module 100 and output a combined signal to the input port EN of the boosting circuit 200.

The boosting circuit 200 boosts the combined signal and outputs a boosted combined signal to the LCD 20, thereby changing the backlighting of the LCD 20 to save energy. As the CABC signal is directly input to the input port EN of the boosting circuit 200, when the duty cycle of the CABC signal changes, the backlighting of the LCD 20 changes proportionately in accordance with the display information on the LCD 20 corresponding to the display control signal.

The combining circuit 400 is a diode D, and an anode of the diode D is connected to the display signal output module 100 and the input port EN of the boosting circuit 200, a cathode of the diode D is connected to CABC control module 300. When the CABC signal is logic low (level), the diode D is turned on, thereby a voltage of the input port EN of the boosting circuit 200 is pulled low, thus decreasing the backlighting of the LCD 20 to save energy.

In high temperature conditions, the performance of the diode D is not stable, if a reverse current of the diode D is too large, it will affect the display control signal connected to the input port EN of the boosting circuit 200, thus affecting the backlighting of the LCD 20. Thus, the combining circuit 400 is selected for suitability with a small reverse current.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A circuit with power saving function connected to a LCD, the circuit comprising:
a display signal output module, to output a display control signal;
a boosting circuit;
a Content Adaptive Backlight Control (CABC) control module, to output a CABC signal; and
a combining circuit, connected between the display signal output module and the CABC control module, to combine the display control signal outputted by the display signal output module and the CABC signal outputted by the CABC control module, then output a combined signal to an input port of the boosting circuit,
wherein the boosting circuit is configured to boost the combined signal and output a boosted combined signal to the LCD, thereby changing the backlighting of the LCD to save energy.

2. The circuit with power saving function of claim 1, wherein the combining circuit is a diode, and an anode of the diode is connected to the display signal output module and the input port of the boosting circuit, a cathode of the diode is connected to CABC control module.

3. The circuit with power saving function of claim 1, wherein the combining circuit is selected for suitability with a small reverse current.
